(19) United States
(12) Patent Application Publication
(10) Pub. No.: US 2005/0259250 A1
(43) Pub. Date: Nov. 24, 2005

(54) Method for measuring a spectrum of a sample by means of an infrared spectrometer and infrared spectrometer of this type

(75) Inventor: Arno Simon, Karlsruhe (DE)

Correspondence Address: KUDIRKA & JOBSE, LLP, ONE STATE STREET, SUITE 800, BOSTON, MA, 02109, US

(73) Assignee: Bruker Optik GMBH, Ettlingen (DE)

(21) Appl. No.: 11/130,435

(22) Filed: May 16, 2005

(30) Foreign Application Priority Data
May 19, 2004 (DE) 10 2004 025 448.6

(51) Int. Cl. B01D 59/44

(52) U.S. Cl. 356/300

(57) ABSTRACT

A method for measuring a spectrum of a sample by means of an infrared spectrometer is described, the spectrometer comprising at least one component whose operating behavior is influenced by at least one operating parameter which, in the event of a change, changes the operating behavior of the at least one component and thereby influences the spectrum to be measured, the method comprising detecting the at least one operating parameter at least once during the measurement of the spectrum, reckoning back the operating behavior of the at least one component in a manner dependent on the detected operating parameter to a predetermined reference value of the operating parameter, and further conducting at least one of the following steps: measuring the spectrum on the basis of the predetermined reference value of the operating parameter, correcting the spectrum on the basis of the predetermined reference value of the operating parameter.

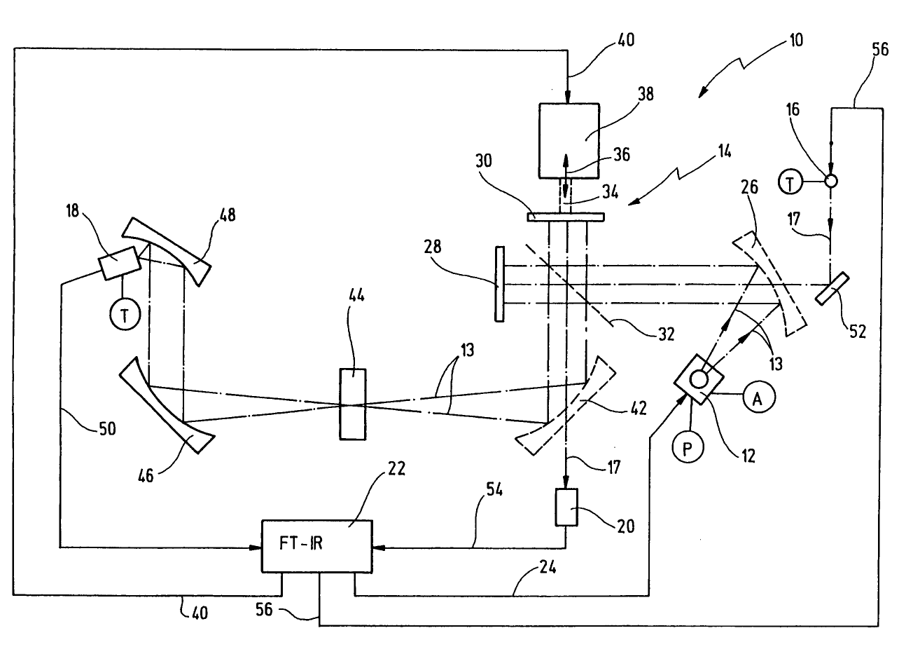

### CROSS REFERENCE TO RELATED APPLICATION

The present application claims priority of German patent application 10 2004 025 448.6 filed on May 19, 2004.

### BACKGROUND OF THE INVENTION

The invention relates to a method for measuring a spectrum of a sample by means of an infrared spectrometer, the spectrometer having at least one component whose operating behavior is influenced by at least one operating parameter which, in the event of a change, changes the operating behavior of the at least one component and thereby influences the measured spectrum.

The invention furthermore relates to an infrared spectrometer for measuring a spectrum of a measurement sample, the spectrometer having at least one component whose operating behavior is sensitive toward a change in at least one operating parameter.

A method and an infrared spectrometer of the types mentioned in the introduction are disclosed for example in the document US 2003/0189709 A1.

It is known that the quality of the result of the measurement of a spectrum of a sample depends on the operating behavior of the spectrometer. Optimum measurement results are obtained when it is possible for the operating behavior of individual spectrometer components or of the entire spectrometer to be kept constant. However, the operating behavior of individual spectrometer components may change with regard to specific operating parameters which depend on the operating conditions, and which may be of intrinsic nature or are influenced by the environment of the spectrometer.

Thus, by way of example, the temperature of individual spectrometer components or of the entire spectrometer, in particular a change in the temperature during the measurement, influences the measurement result. In spectrometers of this type, laser diodes are often used as a reference light source for determining the wave number axis of the spectrum. However, such laser diodes are not stable with regard to the emission wavelength. The latter depends on temperature and current. If the current can be kept constant, the temperature is critical. If the measurement duration increases, such laser diodes heat up, with the consequence that the emitted wavelength drifts depending on the temperature. However, a change in the ambient temperature also effects such a drift in the emission wavelength. The wave number accuracy of the spectrum is thus lost during the measurement of the spectrum, which impairs the quality of the measurement result.

In order to ensure the optimum function of the spectrometer and thus the quality of the measurement, great efforts are undertaken, as described in the document US 2003/0189709 A1 cited above, to keep the operating parameters of the spectrometer constant. Thus, this document proposes operating the reference light source, which is a vertical cavity surface-emitting laser (VCSEL) diode, in an air-conditioned environment. However, this represents a considerable outlay since a closed-loop control is required for the air conditioning, which represents a considerable portion of the costs of such a spectrometer.

A further spectrometer component whose operating behavior depends on the temperature, for example, is the detector of the spectrometer, the response of which likewise exhibits a temperature drift.

However, not just the temperature can influence the operating behavior of individual spectrometer components or of the entire spectrometer. Thus, by way of example, the radiation amplitude of the measurement light source may vary during the measurement, for example on account of fluctuations of the voltage or of the current in the case of semiconductor laser light sources. In this case, too, it has hitherto been attempted, with a high outlay, to stabilize the spectrometer components with regard to their operating parameters.

### SUMMARY OF THE INVENTION

The invention is based on the object of specifying a method and an infrared spectrometer of the types mentioned in the introduction which make it possible, without an increased outlay, to measure a spectrum of a measurement sample with high measurement accuracy.

According to an aspect of the invention, a method for measuring a spectrum of a sample by means of an infrared spectrometer is provided, said spectrometer comprising at least one component whose operating behavior is influenced by at least one operating parameter which, in the event of a change, changes said operating behavior of said at least one component and thereby influences said spectrum to be measured, the method comprising detecting said at least one operating parameter at least once during the measurement of said spectrum, reckoning back said operating behavior of said at least one component in a manner dependent on said detected operating parameter to a predetermined reference value of said operating parameter, and further conducting at least one of the following steps: measuring said spectrum on the basis of said predetermined reference value of said operating parameter, correcting said spectrum on the basis of said predetermined reference value of said operating parameter.

According to another aspect of the invention, an infrared spectrometer is provided, comprising at least one component whose operating behavior is sensitive towards a change in at least one operating parameter, further comprising first means for detecting said at least one operating parameter, and second means for reckoning back said operating behavior of said at least one component, in a manner dependent on said detected operating parameter.

Instead of attempting, as in the prior art, to keep the operating conditions constant in order to avoid drifting of the operating behavior of individual spectrometer components or of the entire spectrometer, which constitutes a high outlay, the present invention proposes detecting the operating parameters of the spectrometer components at least once during the measurement and reckoning back the operating behavior of the components, on the basis of the detected operating parameters, to a constant reference value of the operating parameters or correcting the spectrum. In this way it is possible in particular to dispense with, insofar as the operating parameter is the temperature, operating the spectrometer in a specially conditioned, in particular air-conditioned, environment, rather the spectrometer can be operated in a customary laboratory environment. Complicated open-loop and closed-loop controls for the temperature, for example, are thus advantageously not required. The invention is based on the insight that the operating behavior of specific spectrometer components or of the entire spectrometer is deterministic with regard to specific operating parameters. From knowledge of the functional relationship between the operating behavior and the operating parameter, it is possible to calculate the correct operating behavior that would be present given a constant specific operating parameter. The reckoning back of the operating behavior of the correction of the spectrum in a manner dependent on the detected operating parameter may be carried out for example in a computer unit, by means of a program stored therein.

The first means provided in the infrared spectrometer according to the invention may be sensors, for example, which are used to detect operating parameters, such as, for example, the temperature or the pressure of individual spectrometer components or simply of the environment of the spectrometer, or it is possible, if the operating parameters are operating parameters such as the radiation amplitude of the measurement light source, to use corresponding measuring elements that are directly coupled to the corresponding components. In the case of laser diodes, the current intensity may also be detected as an operating parameter.

In one preferred refinement, the at least one operating parameter is detected continuously during the measurement of the spectrum.

This measure has the advantage that the change in the operating behavior of individual spectrometer components can be determined particularly exactly and a precise reckoning back to the predetermined reference value can be effected. The detection of the operating parameters can be effected continuously or at discrete points in time during the measurement.

In one preferred refinement, the operating behavior of the at least one component is determined in a manner dependent on the at least one operating parameter prior to the measurement of the spectrum.

This measure has the advantage that it is possible firstly to ascertain, on the basis of one or more reference measurements, whether and on what operating parameters the operating behavior of individual spectrometer components or of the entire spectrometer depends. The functional relationship between the operating behavior and the operating parameters that is obtained during this reference measurement can then be stored in the abovementioned computer unit in order, from said functional relationship, to reckon back the operating behavior of the components or to calculate the spectrum. In this case, it is not necessary to determine the operating behavior of the individual spectrometer components depending on the change in the operating parameters anew prior to each measurement of a spectrum, rather this can be effected from time to time at relatively long time intervals. The repetition of such reference measurements at relatively long time intervals also makes it possible to computationally eliminate long-term drifting of the operating behavior of individual components based on aging of the components.

The previously determined dependence on one or more operating parameters can also be programmed in. In order to have to calculate only small deviations, the operating point of the spectrometer is determined anew occasionally by reference measurements or in a manner dependent on the actual values of the operating parameters.

In this connection, it is preferred for the operating behavior of the at least one component to be determined in a manner dependent on the change in the at least one operating parameter on the basis of a reference sample with a known spectrum.

Carrying out a reference measurement on the basis of a reference sample with a known spectrum has the advantage that the operating behavior depending on the at least one operating parameter can be ascertained particularly accurately, which benefits the quality of the measurement of the spectrum of a sample that is to be measured. Wavelength standards such as, for example, water vapor, gases or else polystyrene may advantageously be used as reference samples.

In a further preferred refinement, the operating behavior of the at least one component is reckoned back during the measurement of the spectrum, and the spectrum is corrected in a manner dependent on the detected operating parameter during the measurement of the spectrum.

In this case, it is advantageous that the recording of a spectrum is not temporally delayed by the correction, because the correction is effected simultaneously during the recording of the spectrum.

Provision may nevertheless be made, however, for correcting the measured spectrum in a manner dependent on the detected operating parameter after the measurement of the spectrum if the associated time delay is unimportant.

In a further preferred refinement, the dependence of the operating behavior of the at least one component on the at least one operating parameter is determined in the vicinity of the predetermined reference value of the operating parameter.

The operating parameters during the measurement of a spectrum usually only change over a small parameter range, so that this measure has the advantage of keeping down the outlay for determining the dependence of the operating behavior on the operating parameters.

In this connection, it is further preferred for the spectrometer to be calibrated to the predetermined reference value.

In this case, it is advantageous that the dependence of the operating behavior of the spectrometer components on the operating parameters has to be known only in the vicinity of the local reference value, which, as mentioned above, has the advantage of a lower outlay in ascertaining this dependence.

As already mentioned in the introduction, the at least one operating parameter may be influenced by at least one ambient parameter, the at least one ambient parameter in this case being detected during the measurement of the spectrum. Such an ambient parameter is, in particular, the ambient temperature of individual spectrometer components or of the entire spectrometer, or for example the ambient pressure of a component of the spectrometer or of the entire spectrometer, or else for example the ambient humidity of a spectrometer component or of the entire spectrometer.

Equally, the at least one operating parameter may be an intrinsic operating parameter of the at least one component, such as, for example, the internal temperature of the internal pressure of a component or, for example, the radiation amplitude of the measurement light source.

Insofar as the present description talks of a correction of the spectrum, this is also to be understood to mean that, by way of example, only the x axis of the spectrum, i.e. the wave number axis of the spectrum, is corrected. In the case where the at least one detected operating parameter is the amplitude of the measurement light source, the correction of the spectrum may additionally or alternatively encompass the correction of the y axis (amplitude).

The at least one component of the spectrometer whose operating behavior is sensitive toward the at least one operating parameter may be for example a detector, a measurement light source and/or a reference light source of the spectrometer, to mention preferred examples here.

Further features and advantages emerge from the description below and the accompanying drawing.

It goes without saying that the features mentioned above and features that are still to be explained below can be used not only in the combination respectively specified but also in other combinations or on their own without departing from the scope of the present invention.

### BRIEF DESCRIPTION OF THE DRAWING

A selected exemplary embodiment of the invention is illustrated in the drawing and is described in more detail with reference thereto hereinafter.

The single FIGURE shows an extremely schematic block diagram of an infrared spectrometer, in particular Fourier transform infrared spectrometer.

### DETAILED DESCRIPTION OF A PREFERRED EMBODIMENT

The FIGURE illustrates a Fourier transform infrared spectrometer provided with the general reference symbol 10.

The spectrometer 10 has as components a measurement light source 12, which generates and emits measurement light 13, an interferometer 14, a reference light source 16, which emits reference light 17, a first detector 18 for the measurement light and a second detector 20 for the reference light, and also a control unit 22, which controls the functions of the components of the spectrometer 10.

A first control line 24 runs from the control unit 22 to the measurement light source 12. The measurement light 13 generated and emitted by the measurement light source 12 firstly falls onto a first semitransparent parabolic mirror 26 and is reflected at the latter into the interferometer 14, which is a Michaelson interferometer.

The interferometer 14 has a spatially fixed plane mirror 28, a moveable plane mirror 30 arranged at right angles to the latter, and also a beam splitter 32 arranged at 45° to the mirrors 28 and 30.

The moveable plane mirror 30 is positionally adjustable by means of an actuator 34, to be precise in directions of a double arrow 36. The actuator 34 is controlled by an actuating unit 38, which is in turn connected to the control unit 22 via a second control line 40.

The measurement light 13 that emerges from the interferometer 14 again, is focused onto a sample 44, the infrared spectrum of which is intended to be measured, by a second semitransparent parabolic mirror 42. As revealed by the FIGURE, the sample 44 is measured in transmission, i.e. the measurement light 13 passes through the sample 44, and, in the further course, the measurement light 13, after passing through the sample 44, is directed by a further parabolic concave mirror 46 and yet another parabolic concave mirror 48 onto the first detector 18 for measuring the spectrum of the sample 44. The first detector 18 is likewise connected to the control unit 22 via a third control line 50.

The path difference between the mirrors 28 and 30 of the interferometer 14 is varied during the measurement of the spectrum of the sample 44. The reference light branch of the spectrometer 10, encompassing the reference light source 16, is utilized for defining the x axis of the spectrum to be measured. The reference light source 16 is a VCSEL diode in the present case. The reference light 17 emitted by the reference light source 16 is coupled into the interferometer 14 from a mirror 52 and, after passing through the interferometer 14, the reference light 17 falls onto the second detector 20, which is connected to the control unit 22 by means of a fourth control line 54. The control unit 22 uses the signal of the second detector 20 fed via the fourth control line 54 for feeding an actuating signal to the actuating unit 38 via the second control line 40 in order to actuate the actuator 34. The control unit 22 is furthermore connected to the reference light source 16 via a fifth control line 56.

The above-described components of the spectrometer 10 are sensitive toward changes in specific operating parameters, in such a way that a change in said operating parameters influences or changes the operating behavior of the components of the spectrometer 10, and can thus corrupt the spectrum to be measured from the sample 44. For a measurement result that is as exact as possible, i.e. a spectrum of the sample 44 that is as exact as possible, it is essential that the operating parameters toward a change in which the individual components are sensitive are as far as possible constant during the measurement. Instead, however, of keeping the operating parameters constant with a high outlay, the present invention now proceeds as follows.

During the measurement of the spectrum of the sample 44, the operating parameters are not kept constant, but rather are detected at least once, preferably continuously during the measurement, and the operating behavior of the individual components of the spectrometer is reckoned back, in a manner dependent on the detected operating parameters, to a predetermined reference value of the corresponding operating parameters, on the basis of which the spectrum is calculated or corrected. This will be described in more detail below with reference to some examples.

The reference light source 16, which is a VCSEL diode in the present case, must emit an as far as possible stable wavelength. It is known, however, that laser diodes heat up as the radiation duration increases, and that the emission wavelength drifts as the temperature of the laser diode increases. However, the alteration of the emission wavelength of the reference light source 16 adversely influences the currently picked up spectrum of the sample 44, to be precise with regard to the wave number accuracy of the spectrum (x axis of the spectrum).

Instead, then, of keeping the temperature of the reference light source 16 constant for the purpose of avoiding this drifting, the drifting is permitted, but instead the temperature T of the reference light source 16 is continuously detected during the measurement of the spectrum of the sample 44, and, from the precisely measured temperature T of the reference light source 16, the wavelength of the reference light source 16 is reckoned back to a wavelength value at a specific reference temperature, for example to which the reference light source 16 is calibrated.

For the detection of the temperature T of the reference light source 16, the spectrometer 10 correspondingly has first means for detecting this operating parameter, i.e. the temperature T, for example a temperature measuring sensor provided at a suitable location at the reference light source 16.

The temperature T of the reference light source that is detected during the measurement of the spectrum of the measurement sample 44 is fed into the control unit 22 via a further control line (not illustrated), the reckoning back of the wavelength, i.e. the x axis of the spectrum to the reference value being performed in said control unit, preferably during the measurement of the spectrum of the sample 44.

The dependence of the emission wavelength of the reference light source 16 on the temperature T is determined beforehand in a reference measurement by means of a reference sample, the spectrum of the reference sample being known. The dependence of the emission wavelength of the reference light source 16 on the temperature T that is determined in this way is stored in the control unit 22 and is then used for reckoning back the wavelength to the reference wavelength.

A further example is described with reference to the measurement light source 12. The measurement light source 12 emits the measurement light 13 with an amplitude A that has to be constant for an exact measurement result of the measurement of the spectrum of the sample 44. However, the amplitude A of the radiation that is emitted by the measurement light source 12 may likewise vary or fluctuate during the measurement. In order to eliminate the measurement error caused by the fluctuation of the amplitude A, the amplitude A is continuously detected during the measurement of the spectrum of the measurement sample 44, and the spectrum is reckoned back or corrected with regard to its amplitude A (y axis of the spectrum), in a manner dependent on the amplitude A currently detected, to a predetermined reference value of the amplitude A.

In the case where the measurement light source 12 is a gas laser, in particular in the case of Raman spectroscopy, the operating behavior of the measurement light source 12 also depends e.g. on the pressure of the laser; that is to say that the emission wavelength of the measurement light source 12 changes as a result of a change in the pressure.

Therefore, in the present case the pressure p in the measurement light source 12 is continuously detected during the measurement of the spectrum of the sample 44 and the spectrum is corrected or reckoned back with regard to the wave number (x axis), in a manner dependent on the detected pressure p, to a predetermined reference value of the pressure p.

A further example is described with regard to the first detector 18.

The operating behavior of the first detector 18 (the same also applies to the second detector 20) is influenced by the temperature T of the detector 18. A change in the temperature T, for example in the ambient temperature of the detector 18, changes the response of the detector and can thus corrupt the measurement result of the measurement of the spectrum of the measurement sample 44.

In order to eliminate this corruption of the spectrum of the sample 44, the temperature T of the detector 18 or the ambient temperature in the region of the detector 18 is continuously detected during the measurement of the spectrum of the sample 44 and the spectrum is once again corrected, in a manner dependent on this detected operating parameter to a predetermined reference value of this operating parameter, or the spectrum is calculated after reckoning back the operating behavior of the detector 18 to a predetermined reference temperature on the basis of said reference temperature.

In the same or a similar manner, all components of the spectrometer 10 whose operating behavior depends on at least one operating parameter can be provided with corresponding first means for detecting the at least one operating parameter of the respective component in order to measure the spectrum of the measurement sample 44 in a manner dependent on the operating parameter respectively detected.

In the simplest case, it is also possible for example only to provide a temperature measuring sensor directly in the vicinity of the spectrometer 10, which detects the ambient temperature of the spectrometer 10, the operating behavior of every component of the spectrometer 10 that exhibits a temperature dependence then being reckoned back to a specific reference value of the temperature, to be precise each component with the specific temperature dependence of its operating behavior. Although this represents only a coarse elimination of the influence of the temperature T on the measurement result of the measurement of the spectrum of the sample 44, this configuration is also very simple and cost-effective.

The operating behavior of the respective spectrometer component is determined in a manner dependent on the change in the at least one operating parameter prior to the measurement of the spectrum, in which case this does not have to be effected prior to every measurement, but rather may also take place at relatively long time intervals. In this case, the operating behavior of the spectrometer components is determined in a manner dependent on the change in the corresponding operating parameters on the basis of a reference sample with a known spectrum, it being possible to use water vapor, gases or else polystyrene, for example, as such reference samples.

While the measured spectrum can be corrected in a manner dependent on the detected operating parameter during the measurement of the spectrum, provision may also be made for correcting the measured spectrum in a manner dependent on the detected operating parameter after the measurement of the spectrum, a recording of the detection of the operating parameter during the measurement of the spectrum then being stored in the control unit 22.

Provision is furthermore made for determining the dependence of the operating behavior of the individual spectrometer components on the respective operating parameters in the vicinity of the local reference value of the operating parameter, to which the spectrum is reckoned back for the purpose of eliminating the drifting of the operating behavior of the individual components.

From time to time, the spectrometer 10 is then calibrated to the respective local reference value of the operating parameter.

Besides the first means for detecting the at least one operating parameter, which can be configured in the form of measuring sensors, for example, as above, the spectrometer 10 has second means for reckoning back the operating behavior of the components to the respective reference value of the respective operating parameter or for correcting the spectrum, which may be stored as a control program in the control unit 22.

1. A method for measuring a spectrum of a sample by means of an infrared spectrometer, said spectrometer comprising at least one component whose operating behavior is influenced by at least one operating parameter which, in the event of a change, changes said operating behavior of said at least one component and thereby influences said spectrum to be measured, the method comprising
detecting said at least one operating parameter at least once during the measurement of said spectrum,
reckoning back said operating behavior of said at least one component in a manner dependent on said detected operating parameter to a predetermined reference value of said operating parameter, and further conducting at least one of the following steps:
measuring said spectrum on the basis of said predetermined reference value of said operating parameter,
correcting said spectrum on the basis of said predetermined reference value of said operating parameter.

2. The method of claim 1, further comprising detecting said at least one operating parameter continuously during the measurement of said spectrum.

3. The method of claim 1, wherein said at least one operating parameter is influenced by at least one ambient parameter, and further comprising detecting said at least one ambient parameter during the measurement of said spectrum.

4. The method of claim 3, wherein said at least one ambient parameter is the ambient temperature of said component.

5. The method of claim 3, wherein said at least one ambient parameter is the ambient temperature of said entire spectrometer.

6. The method of claim 3, wherein said at least one ambient parameter is the ambient pressure of said component.

7. The method of claim 3, wherein said at least one ambient parameter is the ambient pressure of said entire spectrometer.

8. The method of claim 3, wherein said ambient parameter is the ambient humidity of said component.

9. The method of claim 3, wherein said ambient parameter is the ambient humidity of said entire spectrometer.

10. The method of claim 1, wherein said at least one operating parameter is an intrinsic operating parameter of said at least one component.

11. The method of claim 10, wherein said at least one operating parameter is the temperature of said component.

12. The method of claim 10, wherein said at least one operating parameter is the pressure of said at least one component.

13. The method of claim 10, wherein said at least one operating parameter is the radiation amplitude of said at least one component.

14. The method of claim 10, wherein said at least one operating parameter is the current intensity applied to said component.

15. The method of claim 1, further comprising determining said operating behavior of said at least one component in a manner dependent on said at least one operating parameter prior to the measurement of said spectrum.

16. The method of claim 15, further comprising determining said operating behavior of said at least one component in a manner dependent on a change in said at least one operating parameter on the basis of a reference sample with a known spectrum.

17. The method of claim 1, wherein said correcting of said spectrum is performed during the measurement of said spectrum.

18. The method of claim 1, wherein said correcting of said spectrum is performed after the measurement of said spectrum.

19. The method of claim 1, further comprising determining the dependence of said operating behavior of said at least one component on said at least one operating parameter in the vicinity of said predetermined reference value of said operating parameter.

20. The method of claim 19, further comprising calibrating said spectrometer to said predetermined reference value prior to the measurement of said spectrum.

21. The method of claim 1, said at least one component being at least one of the following: a detector of said spectrometer, a measurement light source of said spectrometer, a reference light source of said spectrometer.

22. An infrared spectrometer for measuring a spectrum of a measurement sample, said spectrometer comprising at least one component whose operating behavior is sensitive towards a change in at least one operating parameter, further comprising first means for detecting said at least one operating parameter, and second means for reckoning back said operating behavior of said at least one component, in a manner dependent on said detected operating parameter.

23. The spectrometer of claim 22, further comprising means for correcting said spectrum in a manner dependent on said detective operating parameter.
